(19) United States
(12) Patent Application Publication
(10) Pub. No.: US 2014/0372169 A1
(43) Pub. Date: Dec. 18, 2014

(54) SYSTEMS AND METHODS FOR PROVIDING BUSINESS RATINGS

(71) Applicants: Phillip KIM, New York, NY (US); Alex HASHA, Brooklyn, NY (US); Jaidev SHERGILL, New York, NY (US); Homin LEE, Jersey City, NJ (US); Simon FREEDMAN, Chicago, IL (US)

(72) Inventors: Phillip KIM, New York, NY (US); Alex HASHA, Brooklyn, NY (US); Jaidev SHERGILL, New York, NY (US); Homin LEE, Jersey City, NJ (US); Simon FREEDMAN, Chicago, IL (US)

(73) Assignee: CAPITAL ONE FINANCIAL CORPORATION, McLean, VA (US)

(21) Appl. No.: 14/308,268

(22) Filed: Jun. 18, 2014

Related U.S. Application Data
(60) Provisional application No. 61/836,499, filed on Jun. 18, 2013.

(51) Int. Cl. G06Q 30/02

(52) U.S. Cl. CPC G06Q 30/0201
USPC 705/7.29

(57) ABSTRACT

The disclosed embodiments include methods, systems, and articles of manufacture for providing business ratings. The disclosed embodiments include, for example, a system that may be configured to access spending transaction data including at least a unique payor identifier, a payee description, a payee category code, and a postal code. The system may determine a payee identification for the spending transaction data by comparing the spending transaction data to a plurality of known payees having the same payee category code as the spending transaction data. Further, the system may access one or more historical spending transactions matching the payee category code, and generate a business rating score for a payee associated with the determined payee identification based on at least the determined one or more historical spending transactions.

### CROSS-REFERENCE TO RELATED APPLICATIONS

This application claims benefit to U.S. Provisional Patent Application No. 61/836,499, filed Jun. 18, 2013, which is incorporated herein by reference in its entirety.

### BACKGROUND

When consumers consider becoming customers of a business, they often research the quality of the business. Consumers may consult friends and family to learn of a business's reputation through word of mouth. Consumers may also consult third parties that rate business. Some of these third parties use a business rating score that indicates the business's reputation. For example, when a consumer considers going to a new restaurant, the consumer may consult a published restaurant guide or perform an Internet search to find reviews of the restaurant posted by other Internet users.

Current business rating systems rely on data provided through the opinion of others. These business rating systems commonly rely on the compilation of quantitative or qualitative feedback volunteered by others. For example, current business rating systems may use survey data complied through mailers, or current business rating systems may use websites to solicit opinions from consumers. As a result, current business rating systems are dependent on the subjective data provided by consumers, and are not based on quantifiable, objective data. In addition, current business rating systems are subject to the consumers' desire to volunteer opinion and only those businesses for which consumers have volunteered information can be rated.

### SUMMARY

Disclosed embodiments include methods, systems, and articles of manufacture configured to, for example, provide business ratings that are presented on one or more client devices associated with a user (or group of users). In some embodiments, the business ratings may be determined based on spending transaction data accessed from one or more financial data systems.

The disclosed embodiments include, for example, a system for determining business ratings. The system may access spending transaction data that can include at least a unique payor identifier, a payee description, a payee category code, and a postal code. The system may determine a payee identification for the spending transaction data by comparing the spending transaction data to a plurality of known payees having the same payee category code as the spending transaction data. To generate a business rating score for a payee associated with the determined payee identification, one or more historical spending transactions may be accessed. The generated business rating score may be based, at least in part, on the historical spending transactions.

The disclosed embodiments also include, for example, a computer-implemented method for determining business ratings. In one aspect, the method may include accessing spending transaction data that can include at least a unique payor identifier, a payee description, a payee category code, and a postal code. The method may also include determining a payee identification for the spending transaction data by comparing the spending transaction data to a plurality of known payees having the same payee category code as the spending transaction data. To generate a business rating score for a payee associated with the determined payee identification, the method may include accessing one or more historical spending transactions. The generated business rating score may be based, at least in part, on the historical spending transactions.

The business rating score is generated by determining the historical transactions associated with a payor, determining which of those historical transactions are associated with payee, determining which of those historical transactions are not associated with the payee, and comparing the payor historical transactions associated with the payee to the transactions not associated with the payee, in some disclosed embodiments. The business ratings score may also be generated by determining which historical transactions are associated with the payee, determining which historical transactions are not associated with the payee, and comparing the one or more historical transactions associated with the payee to the one or more historical transactions not associated with the payee.

It is to be understood that both the foregoing general description and the following detailed description are exemplary and explanatory only and are not restrictive of the disclosed embodiments, as claimed.

The accompanying drawings, which are incorporated in and constitute a part of this specification, illustrate disclosed embodiments and, together with the description, serve to explain the disclosed embodiments.

### BRIEF DESCRIPTION OF THE DRAWINGS

FIG. 1 is a block diagram of an exemplary system, consistent with disclosed embodiments.

FIG. 2 is a block diagram of another exemplary system, consistent with disclosed embodiments.

FIG. 3 is a block diagram of another exemplary system, consistent with disclosed embodiments.

FIG. 4 is a flowchart of an exemplary business rating process consistent with disclosed embodiments.

FIG. 5 is a flowchart of an exemplary payee identification process consistent with disclosed embodiments.

FIG. 6 is a flowchart of an exemplary loyalty business rating score process consistent with disclosed embodiments.

FIG. 7 is a flowchart of an exemplary comparative business rating score process consistent with disclosed embodiments.

### DETAILED DESCRIPTION

Reference will now be made in detail to the disclosed embodiments, examples of which are illustrated in the accompanying drawings. Wherever convenient, the same reference numbers will be used throughout the drawings to refer to the same or like parts.

As current business ratings systems rely on subjective, volunteered data, they are prone to incomplete, and sometimes, inaccurate information. Current business ratings systems are prone to selection bias or other survey biases that may provide an inaccurate picture of the popularity of a business. The embodiments of the present disclosure solves this problem, and others, by using spending transaction data to rate businesses. When consumers (or “payors”) use a credit card, debit card, or some other form of electronic payment at a business (or “payee”), the transaction is recorded by one or more financial data systems. The business rating system of the disclosed embodiments accesses the transactions from the one or more financial data systems, and uses the spending transaction data to determine business ratings. By using actual spending transaction data, as opposed to using only survey data, the business rating system of the present disclosure can provide a more accurate assessment of the popularity or overall quality of a business.

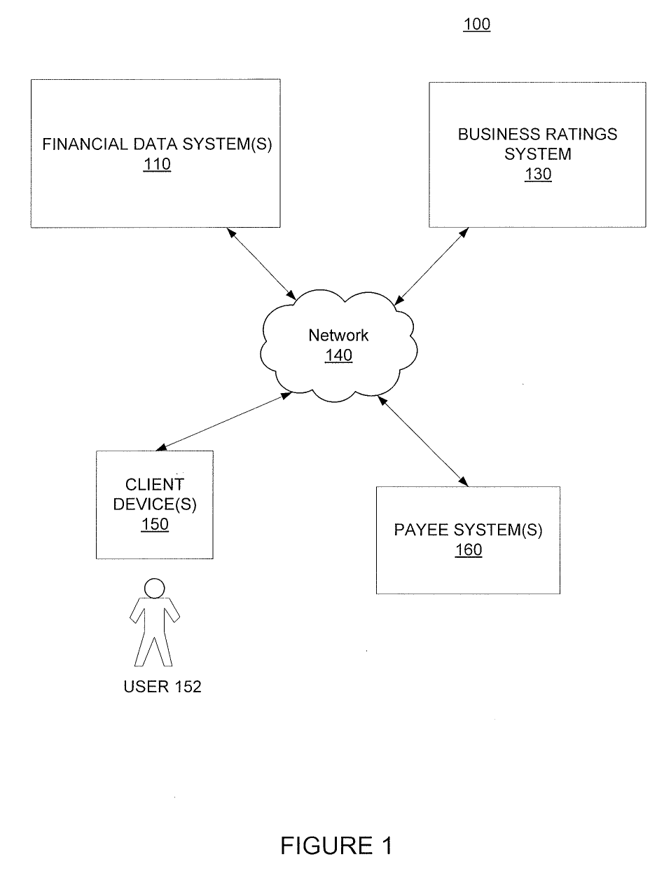

FIG. 1 is a block diagram of an exemplary system 100 for performing one or more operations consistent with the disclosed embodiments. In one embodiment, system 100 may include one or more financial data system(s) 110, one or more business ratings systems 130, one or more clients devices 150, one or more payee systems 160, and a network 140. The components and arrangement of the components included in system 100 may vary. Thus, system 100 may include other components that perform or assist in the performance of one or more processes consistent with the disclosed embodiments.

Components of system 100 may be computing systems configured to provide business ratings consistent with disclosed embodiments. As further described herein, components of system 100 may include one or more computing devices (e.g., computer(s), server(s), etc.), memory storing data and/or software instructions (e.g., database(s), memory devices, etc.), and other known computing components. In some embodiments, the one or more computing devices are configured to execute software instructions stored on one or more memory devices to perform one or more operations consistent with the disclosed embodiments. Components of system 100 may be configured to communicate with one or more other components of system 100, including financial data system(s) 110, business ratings system 130, client devices 150, and/or payee systems 160. In certain aspects, users may operate one or more components of system 100 to initiate one or more operations consistent with the disclosed embodiments. In some aspects, the one or more users may be employees of, or associated with, the entity corresponding to the respective component(s) (e.g., someone authorized to use the underlying computing systems or otherwise act on behalf of the entity). In other aspects, the user may not be an employee or otherwise associated with underlying entity. In still other aspects, the user may itself be the entity associated with the respective component (e.g., user 152 operating client device 150).

Financial data system(s) 110 may be a system associated with an entity making financial data available. For example, financial data system(s) 110 may be associated with a bank, credit card issuer, credit bureau, credit agency, or other entity that generates, provides, manages, and/or maintains financial data for one or more users. Financial data may include, for example, credit card account data, credit card transactions, checking or savings account data and transactions, loan accounts and transactions, reward or loyalty program account data and transactions, and/or any other type of financial data known to those skilled in the art. Financial data system(s) 110 may include infrastructure and components that are configured to generate and/or provide financial service accounts such as credit card accounts, checking accounts, debit card accounts, loyalty or reward programs, lines of credit, and the like.

Business ratings system 130 may be a computing system configured to provide advertising and/or marketing services consistent with disclosed embodiments, as further described herein. In one embodiment, business ratings system 130 may be related to an entity that provides ratings or scores associated with businesses. For example, business ratings system 130 may provide scores related to a restaurant's popularity, customer loyalty, or other business attributes related to the restaurant. According to some embodiments, business ratings system 130 may include a computing system operated by one of the entities associated with financial data system(s) 110. Business ratings system 130 may include one or more computing devices (e.g., server(s)), memory storing data and/or software instructions (e.g., database(s), memory devices, etc.) and other known computing components. Business ratings system 130 may be configured to communicate with one or more components of system 100, such as financial data system(s) 110, payee systems 160, and/or client devices 150. Business ratings system 130 may be configured to provide business ratings via an interface(s) accessible by users over a network (e.g., the Internet). For example, business ratings system 130 may include a web server that hosts a web page accessible through network 140 by client device(s) 150. In some embodiments, client devices(s) may execute an application that communicates with business ratings system 130 and accesses business ratings from business ratings system 130 and displays the business ratings on its display through a graphic user interface.

Client device(s) 150 may be one or more computing devices configured to perform one or more operations consistent with disclosed embodiments. Client device 150 may be a desktop computer, a laptop, a server, a mobile device (e.g., tablet, smart phone, etc.), or any other type of computing device. Client device 150 may also include a television, e-reader, or any other type of device capable of communicating with other components of system 100 and presenting business ratings content. According to some embodiments, client device 150 may comprise a network-enabled computing device operably connected to one or more other presentation devices, which may themselves constitute client devices 150.

Client device(s) 150 may include one or more processors configured to execute software instructions stored in memory, such as memory included in client device 150. Client device 150 may include software that when executed by a processor performs known Internet-related communication and content presentation processes. For instance, client device 150 may execute software that generates and displays interfaces and/or content on a presentation device included in, or connected to, client device 150. Client device 150 may be a mobile device that executes mobile device applications and/or mobile device communication software that allows client device 150 to communicate with components of system 100 over network 140. The disclosed embodiments are not limited to any particular configuration of client device 150.

Payee system(s) 160 may be computing systems associated with business entities that provide goods, services, and/or information such as a restaurant (e.g., Outback Steakhouse®, Burger King®, etc.), retailer (e.g., Amazon.com®, Target®, etc.), grocery store, service provider (e.g., utility company, etc.), non-profit organization (ACLU™, AARP®, etc.) or any other type of entity that provides goods, services, and/or information that consumers (i.e., end-users or other business entities) may purchase, consume, use, etc. For ease of discussion, the present disclosure may describe exemplary embodiments in the context of business ratings for restaurant payee systems. However, payee system(s) 160 is not limited to systems associated with merchant(s) that conduct business in any particular industry or field.

Payee system 160 may be associated with a merchant brick and mortar location(s) that a consumer (e.g., user 152) may physically visit and purchase goods and services. Such physical locations may include components of payee system 160, which may include computing devices that perform financial service transactions with consumers (e.g., Point of Sale (POS) terminal(s), kiosks, etc.). Payee system 160 may also include back- and/or front-end computing components that store data and execute software instructions to perform operations consistent with disclosed embodiments, such as computers that are operated by employees of the merchant (e.g., back office systems, etc.). Payee system 160 may also be associated with a merchant that provides goods and/or service via known online or e-commerce type of solutions. For example, such a merchant may sell goods via a website using known online or e-commerce systems and solutions to market, sell, and process online transactions. Payee system 160 may include server(s) that are configured to execute stored software instructions to perform operations associated with a merchant, including one or more processes associated with processing purchase transactions, generating transaction data, generating product data (e.g., SKU data) relating to purchase transactions, etc.

Network 140 may be any type of network configured to provide communications between components of system 100. For example, network 140 may be any type of network (including infrastructure) that provides communications, exchanges information, and/or facilitates the exchange of information, such as the Internet, a Local Area Network, or other suitable connection(s) that enables the sending and receiving of information between the components of system 100. In other embodiments, one or more components of system 100 may communicate directly through a dedicated communication link(s), such as links between financial service provider system 110, business ratings system 130, client devices 150, and payee systems 160.

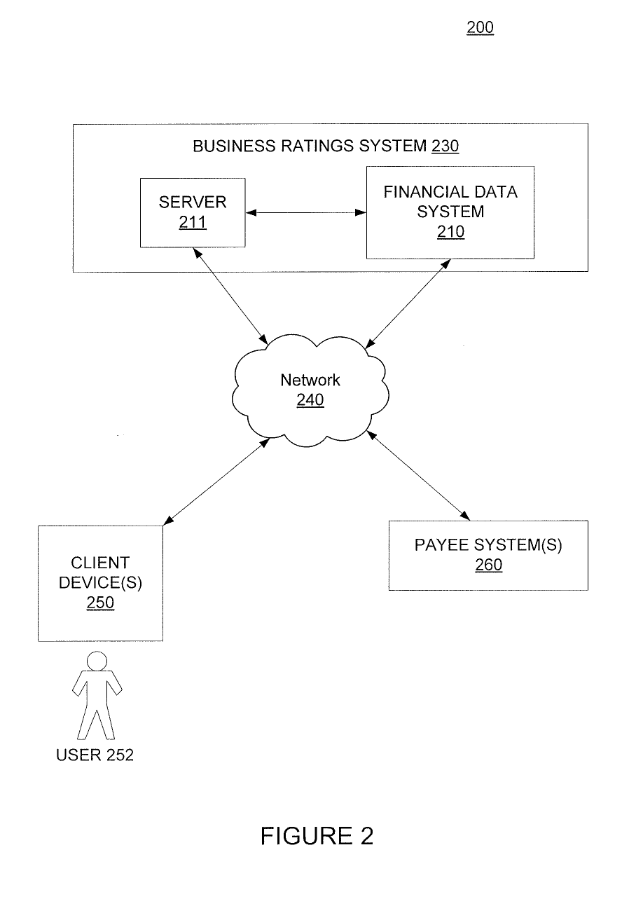

FIG. 2 is a block diagram of another exemplary system 200 for performing one or more operations consistent with the disclosed embodiments. In certain embodiments, business ratings system 230 may be configured to include financial data (or vice versa) consistent with disclosed embodiments. For example, business ratings system 230 may include an financial data system 210 that is configured to provide financial data in a manner consistent with that disclosed above in connection with financial data system(s) 110 shown in FIG. 1. Consistent with disclosed embodiments, financial data system 210 may use or otherwise directly communicate with computing devices of business ratings system 230 (e.g., server 211). Furthermore, business ratings system 230 may directly access memory devices of financial data system 210 (not shown) to retrieve, for example, financial transaction data associated with consumers or merchants. Business ratings system 230 may otherwise be configured and operate similar to business ratings system 130 disclosed above in connection with FIG. 1. Similarly, financial data system 210, client devices 250, and payee systems 260 may be configured and operate similar to similarly labeled components disclosed above in connection with FIG. 1.

It is to be understood that the configuration and boundaries of the functional building blocks of systems 100 and 200 have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. For example, business ratings systems 130, 230 may constitute a part of components of systems 100, 200 other than those specifically described (e.g., payee system 160, 260 and/or client devices 150, 250) or may constitute a part of multiple components of system 100 (i.e., a distributed system). Such alternatives fall within the scope and spirit of the disclosed embodiments.

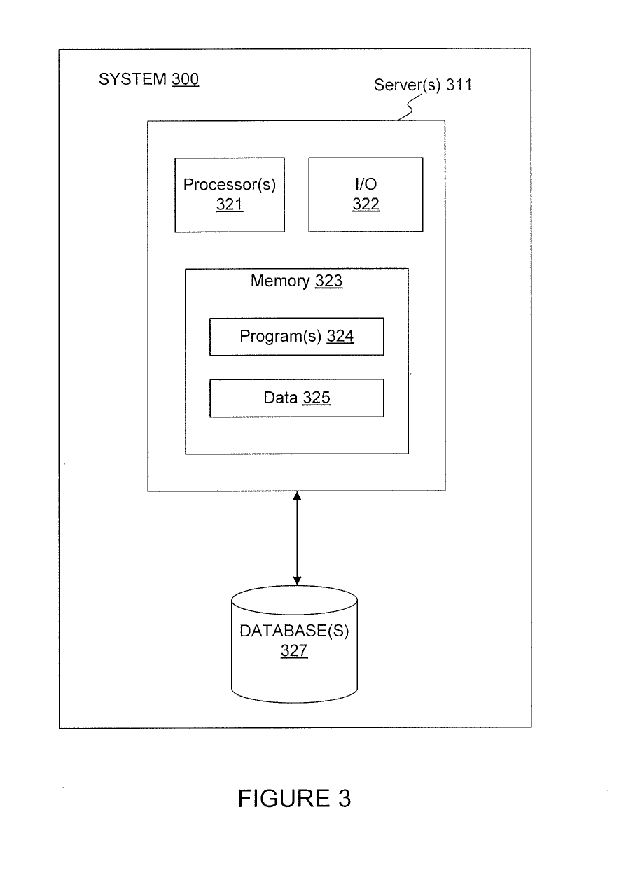

FIG. 3 shows an exemplary system 300 for implementing embodiments consistent with the present disclosure. Variations of exemplary system 300 may be used by financial data system(s) 110, business ratings system 130, client devices 150, and/or payee systems 160. In one embodiment, system 300 may include a server 311 having one or more processors 321, one or more memories 323, and one or more input/output (I/O) devices 322. In some embodiments, server 311 may take the form of a mobile computing device, general purpose computer, a mainframe computer, or any combination of these components. Alternatively, server 311 (or a system including server 311) may be configured as a particular apparatus, embedded system, dedicated circuit, and the like based on the storage, execution, and/or implementation of the software instructions that perform one or more operations consistent with the disclosed embodiments. According to some embodiments, server 311 may comprise web server(s) or similar computing devices that generate, maintain, and provide web site(s) consistent with disclosed embodiments. Server 311 may be standalone, or it may be part of a subsystem, which may be part of a larger system. For example, server 311 may represent distributed servers that are remotely located and communicate over a network (e.g., network 140) or a dedicated network, such as a LAN. Server 311 may correspond to server 211, or separately to any server or computing device included in financial service provider system 110, business ratings system 130, client devices 150, and/or payee systems 160.

Processor 321 may include one or more known processing devices, such as a microprocessor from the Pentium™ or Xeon™ family manufactured by Intel™, the Turion™ family manufactured by AMD™, or any of various processors manufactured by Sun Microsystems. The disclosed embodiments are not limited to any type of processor(s) configured in server 311.

Memory 323 may include one or more storage devices configured to store instructions used by processor 321 to perform functions related to disclosed embodiments. For example, memory 323 may be configured with one or more software instructions, such as program(s) 324 that may perform one or more operations when executed by processor 321. The disclosed embodiments are not limited to separate programs or computers configured to perform dedicated tasks. For example, memory 323 may include a single program 324 that performs the functions of the server 311, or program 324 could comprise multiple programs. Additionally, processor 321 may execute one or more programs located remotely from server 311. For example, financial service provider system 110, business ratings system 130, client devices 150, and/or payee systems 160, may, via server 311, access one or more remote programs that, when executed, perform functions related to certain disclosed embodiments. Memory 323 may also store data 325 that may reflect any type of information in any format that the system may use to perform operations consistent with the disclosed embodiments.

I/O devices 322 may be one or more devices configured to allow data to be received and/or transmitted by server 311. I/O devices 322 may include one or more digital and/or analog communication devices that allow server 311 to communicate with other machines and devices, such as other components of systems 100 and 200.

Server 311 may also be communicatively connected to one or more database(s) 327. Server 311 may be communicatively connected to database(s) 327 through network 140. Database 327 may include one or more memory devices that store information and are accessed and/or managed through server 311. By way of example, database(s) 327 may include Oracle™ databases, Sybase™ databases, or other relational databases or non-relational databases, such as Hadoop sequence files, HBase, or Cassandra. The databases or other files may include, for example, data and information related to the source and destination of a network request, the data contained in the request, etc. Systems and methods of disclosed embodiments, however, are not limited to separate databases. In one aspect, system 300 may include database 327. Alternatively, database 327 may be located remotely from the system 300. Database 327 may include computing components (e.g., database management system, database server, etc.) configured to receive and process requests for data stored in memory devices of database(s) 327 and to provide data from database 327.

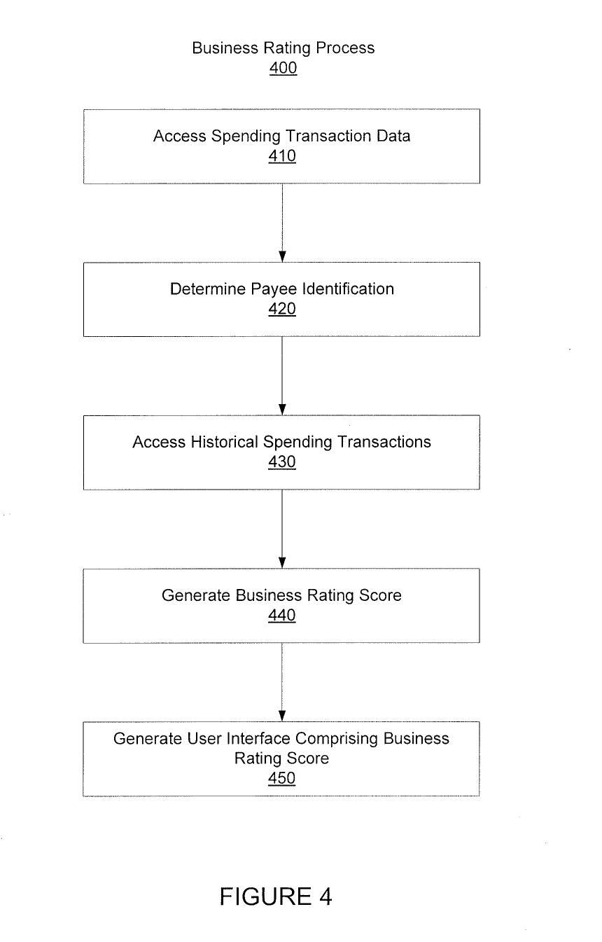

FIG. 4 shows a flowchart of an exemplary business rating process 400 consistent with disclosed embodiments. Business rating process 400 may be performed, for example, by business ratings system 130 on a periodic basis, or in some embodiments, on an as needed basis. For example, business ratings system 130 may perform business rating process 400 hourly, daily, or weekly. Additionally or alternatively, business ratings system 130 may perform business rating process when it receives a request for a business rating or when it receives spending transaction data from financial data system(s) 110.

According to some embodiments, business rating process 400 may begin when business ratings system 130 accesses spending transaction data (step 410). The transaction data may reflect, for example, user purchase transactions at one or more good and/or service providers. In some embodiments, business ratings system 130 accesses the spending transaction data from financial data system(s) 110. The business ratings system 130 may receive the data on a transaction by transaction basis. For example, business ratings system 130 may receive spending transaction data for a single transaction, as the transaction is processed by financial data system(s) 110. In some embodiments, business ratings system 130 may receive the spending transaction data in batch and on a periodic basis. For example, business ratings system 130 may daily access spending transaction data corresponding to all transactions that occurred with the last 24 hours.

Business ratings system 130 may access data by requesting it from financial data system(s) 110, or financial data system(s) 110 may transmit the spending transaction data to business ratings system 130 without prompting. The transaction data may be sent as a data stream, text file, serialized object, or any other method known in the art for transmitting data between computing systems. In some embodiments, financial data system(s) 110 exposes an application programming interface (API) that it makes available to business rating system 130. To access spending transaction data, business rating system 130 may make a function call to the API to receive spending transaction data. Those with skill in the art may contemplate additional methods for data transfer between business rating system 130 and financial data system(s) 110 without changing the scope and sprit of the disclosed embodiments.

As noted above, the spending transaction data may include information regarding one or more consumer transactions. Spending transaction data for a consumer transaction may include, among other things, the date and time for the transaction, the purchase amount for the transaction, a unique payor identifier associated with the transaction, a description of the payee (e.g., merchant) for the transaction, a category code associated with the merchant (e.g., retail goods, medical services, dining), a phone number associated with the merchant, a bank number associated with the merchant, and one or more geographic indicators (e.g., postal code, street address, city, state, GPS coordinates, etc.). As spending transaction data may originate from several financial data system(s) 110, each providing different information for each consumer transaction, the information contained in the spending transaction data originating from a first financial data system may be different from the information contained in spending transaction data originating from a second financial data system.

Consumer transactions reflected in the accessed spending transaction data may include several types of consumer transactions. For example, the consumer transactions may correspond to credit card purchases or refunds, debit card purchases or refunds, eChecks, electronic wallet transactions, wire transfers, etc. The consumer transactions may also include transactions associated with reward or loyalty programs. For example, the consumer transactions may include the number of loyalty points, and their cash equivalent, used to earn discounts or receive free dining. Spending transaction data received from one financial data system may include more than one type of consumer transaction type. For example, spending transaction data received from a bank may include debit card, credit card, and eCheck consumer transactions.

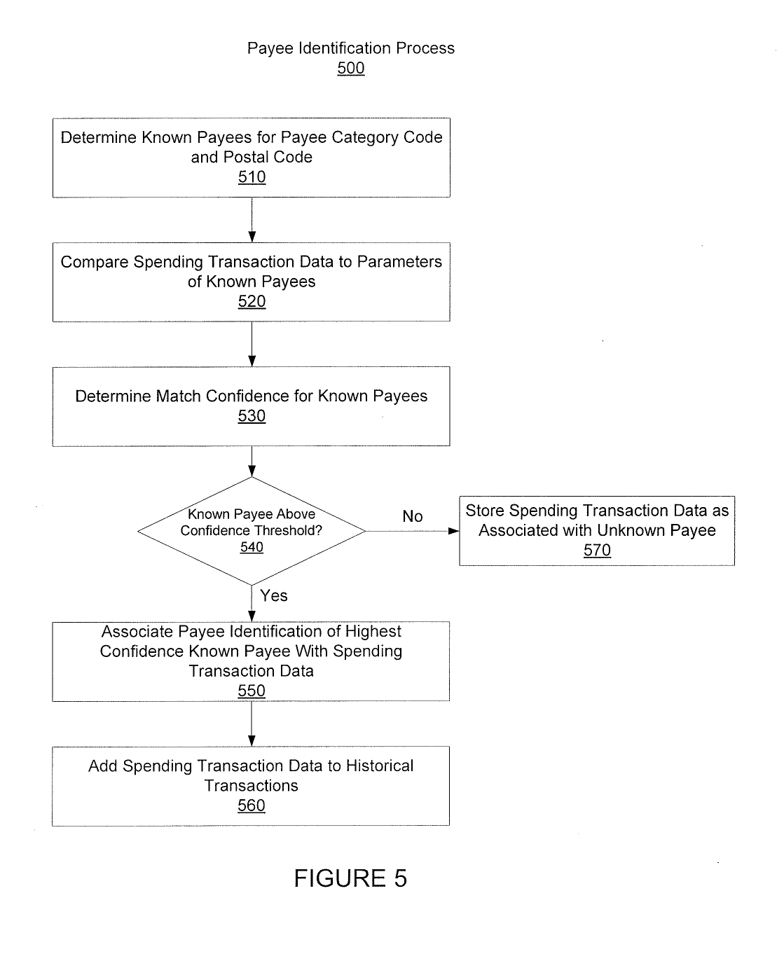

In some embodiments, the spending transaction data does not include a unique identifier for the payee for the transaction, and the business rating system 130 must determine the payee identification (step 420). While the business rating system 130 may identify payees using several different processes, one exemplary payee identification process is shown in FIG. 5.

The business rating system 130 may have access to data associated with a plurality of known payees. The data describing the known payees may include the name and address of the payee, the payee category code of the payee (e.g., retail, restaurant, etc.), typical spending ranges, the payee's phone number, city, state, street address, the payee's bank account number or other information identifying the payee's bank account (account number, routing number, or bank identifier, for example), or other data. As most consumer transactions include at least a category code and a postal code, when the business rating system 130 performs the payee identification process, it may filter the possible known payees to match to the spending transaction data based on the category code of the spending transaction data and the postal code of the spending transaction data (step 510). For example, when the business rating system 130 receives spending transaction data indicating that a consumer transaction took place at a retail merchant in postal code 92603, it may access the data store of known payees and request that only those known payees that are retail merchants located in postal code 92603 are returned. As the list of known payees may range across several postal codes, and across several merchant categories, the business ratings system 130 may narrow the list of possible matching known payees to a consumer transactions by examining only those matching the category code and the postal code of the consumer transaction.

Once the business rating system 130 determines the known payees for the category code and the postal code of the spending transaction data, it may compare the remainder of the spending transaction data to the parameters of the known payees (step 520). The business rating system 130 may compare, for example, the description of the spending transaction data with a description associated with the known payee, and/or the business rating system 130 may compare the purchase amount for the transaction to a typical range of spending transaction amounts for the known payees. In some embodiments, business ratings system 130 may also compare the phone number associated with the spending transaction data to the phone numbers for known payees, or use bank account information associated with the spending transaction data.

As the business ratings system compares spending transaction data to the parameters of known payees, in some embodiments, it may determine a match confidence for each known payee (step 530). The match confidence may be quantitative value that provides an indication of how likely a consumer transaction came from a known payee. The business ratings system 130 may calculate a large amount of match confidence points when there is an exact match between spending transaction data and parameters of a known payee and it may calculate less match confidence points when there is close, but not exact, match between spending transaction data and the known payee. For example, consumer transaction data may include “J CLOTHES ON MAIN,” and the business rating system may be have found two known payees with the descriptions “J. Smith Clothier” and “J Clothes on Main.” “J Clothes on Main” will receive more match confidence points than “J. Smith Clothier.” The business ratings system 130 may award match confidence points based on other data, for example, addresses, transaction amounts, or other information. For example, in some embodiments, business ratings system 130 may award more match confidence points for a purchase of $65 to “J Clothes on Main” based on a determination that purchase transactions associated with “J Clothes on Main” are typically higher than $50 while purchases associated with “J. Smith Clothier” are typically under $35. The match points, in some embodiments, may be converted to a match confidence percentage corresponding to the probability that the known payee is a correct match for the spending transaction data. For example, the business rating system 130 may assign a 50% confidence level to a match between spending transaction data and a known payee, which represents that there is 50% chance that the match is correct.

Once the business rating system 130 determines the match confidence for known payees, it may compare the match confidence to a certain threshold (step 540). The business rating system 130 may use the match confidence threshold to ensure that a minimal amount of false matches between known payees and spending transaction data occur. For example, the business rating system 130 may have a match confidence level of 75%, meaning that a known payee will only be matched with spending transaction data when the match confidence is at least 75%. When there is no known payee with a match confidence above the threshold (step 540: NO), the business rating system 130 may store the spending transaction data and associate it with an unknown payee (step 570). In some embodiments, the business rating system 130 may re-attempt to match spending transaction data associated with unknown payees with known payees on a periodic basis, when known payees are added, or the parameters of known payees are updated.

When there is at least one known payee with a match confidence above the threshold (step 540: YES), the spending transaction data is associated with a unique payee identifier corresponding to the known payee with the highest match confidence level (step 550). Once the spending transaction data has been associated with a payee identifier, it is added to the historical transactions available to business rating system 130 to determine business ratings (step 560).

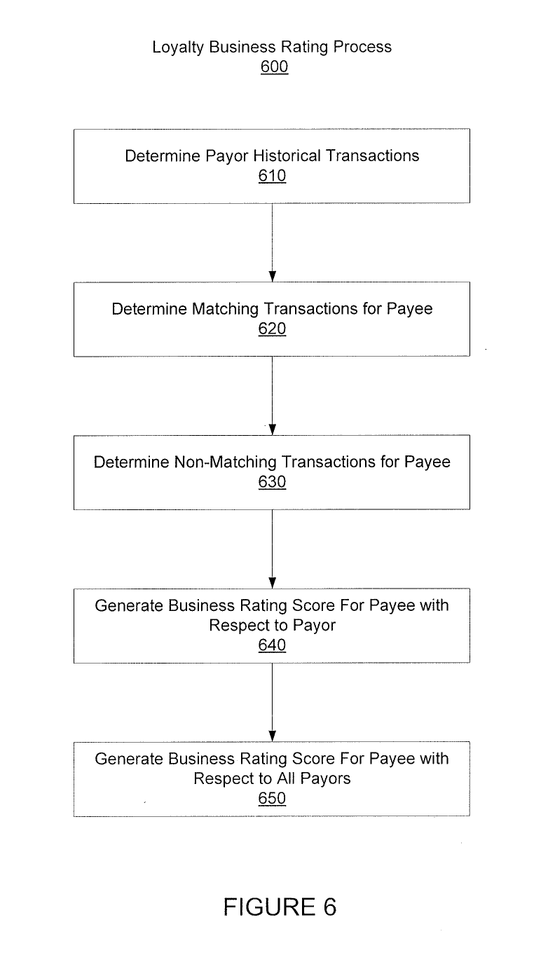

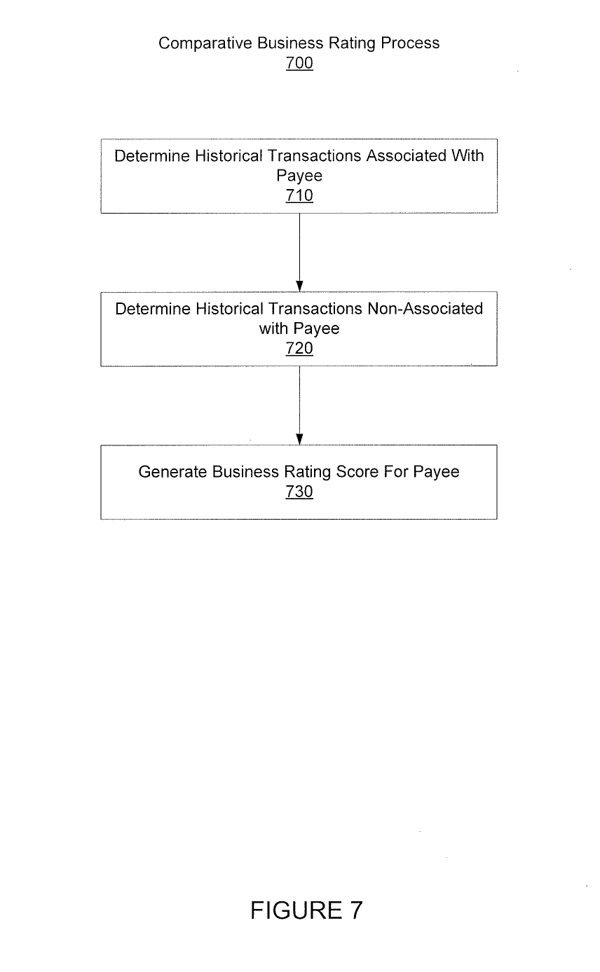

Returning to FIG. 4, once the business rating system 130 has determined the payee identification (step 420), it may access historical spending transactions (step 430). The type of historical spending transactions accessed by the business rating system 130 may depend on the type of business rating score to be determined by the business rating system 130 (step 440). For example, when the business rating system 130 determines a loyalty score for a payee, it may access historical spending transactions for each unique payor identifier for the business category of the payee being rated. Or, when the business rating system 130 determines an overall business rating score or a comparative business rating score, it may access historical spending transactions for each payee that has the same business category of the payee being rated, without concern for the unique payor identifier. The nature of accessed historical spending transactions, and how they are used to determine business rating scores according to exemplary embodiments, is further described with respect to FIG. 6 and FIG. 7.

FIG. 6 shows a flowchart of an exemplary loyalty business rating score generation process 600 consistent with disclosed embodiments. A loyalty business score may provide an indication of how loyal payors are to a particular payee. For example, a loyalty business score may provide an indication of how often a payor frequents a first payee as compared to other payees that are of the same category of the first payee. Alternatively or additionally, a loyalty score for a restaurant may provide an indication of how often payees dine at the restaurant as opposed to dinning at other, competing restaurants.

According to one embodiment, the loyalty business rating score generation process may begin by determining, for a particular payor, the historical transactions matching the payor. The payor may be selected based on received spending transaction data that is currently being processed, or the payor may be selected at random from a group of payors from which the business rating system 130 has collected historical transactions. The historical transactions may be accessed using the unique payor identifier of the stored historical transactions. The unique payor identifier may be, in some embodiments, an anonymized number that is used in place of the account number for a unique payor identifier. In some embodiments, the business rating system 130 may access data related to multiple accounts (e.g., financial spending accounts) of a payor so that spending habits of the payor across payments methods can be used to generate business ratings. For example, a payor may have a first account that is a credit card account and a second account that is a debit card account. The business rating system 130 may use matching logic to associate the first account and the second account with the payor so that when the payor uses the credit card or the debit card at a payee, the payee's business ratings are calculated accurately.

Once the business rating system determines the historical transactions for the payor, it determines how many of those transactions match the payee for which the business rating system 130 is determining a business rating (step 620). As the historical transactions have been assigned payee identifiers (as described with respect to FIG. 5), the business rating system 130 need only find those transactions of the payee that are associated with the payee identifier of the payee that is being rated.

The business ratings system 130 will determine the non-matching transactions for the payee (step 630). The business rating system 130 may find those historical transactions of the payor (determined at step 610) that are of the same category of the payee, but not associated with the payee. For example, if the payee being rated is Ann's Clothing, the business rating system 130 will find those historical transactions of the payor that are for apparel, but not associated with Ann's Clothing.

Once the business rating system 130 determines the matching and non-matching transactions for the payee, it can generate a business rating score for the payee with respect to the payor (step 640). The business rating score may provide an indication of how often a particular payor frequents the payee being rated. For example, Mary (the payor) may have 150 historical transactions associated with Food Mart Grocery (the payee), and 200 historical transactions associated with other grocery stores. Thus, the business rating system 130 may use the ratio of 0.429 (150 transactions at Food Mart Grocery to 350 total grocery store transactions) when it determines the business rating score for Mary with respect to Food Mart Grocery. The business rating system 130 may use additional information when calculating the business rating score for a payee with respect to a payor. For example, the business rating system 130 may include geography, price range, or purchase frequency (e.g., how many times per week), when determining the business rating score for a payee with respect to a payor.

Once the business rating system 130 determines the business rating score for the payee with respect to the payor, it may determine the business rating score for the payee with respect to all payors for which it has historical transactions (step 650). In some embodiments, the business rating score with respect to all payors may be the mean business rating scores for the payee with respect to individual payors. The business rating system 130 may employ additional logic when determining the business rating score. The business rating system 130 may weigh scores from payors based on the amount of historical transaction data collected for the payor. For example, payors that have a large amount of historical transactions may be weighed more heavily in determining the payee's loyalty business rating, and payors that have a small amount of historical transactions may be weighed less heavily. The business rating system 130 may also weigh those payors that are in the same, or close, geographic area as the payees more heavily, than those payors that are not in the same geographic area as the payee.

FIG. 7 shows a flowchart of an exemplary comparative business rating score generation process 700 consistent with disclosed embodiments. In some embodiments, the business rating system 130 rates a payee compared to other payees of the same category. For example, Main Street Cinema may be rated with respect to other movie theaters. Unlike the exemplary loyalty business rating score process of FIG. 6, the exemplary comparative business rating score process of FIG. 7 does not determine business rating scores with respect to payors, but other embodiments may include payor information in the comparative business rating score.

The business rating system 130 may first determine historical transactions with respect to the payee (step 710). For example, if the business rating system 130 is determining the comparative business rating score for Bill's Restaurant, it will find historical transactions with the same payee identifier as Bill's restaurant. Next, the business rating system 130 may determine the historical transactions that are of the same category as the payee, but not associated with the payee (step 720). For example, the business rating system 130 may find historical transactions that are from restaurants, but not from Bill's Restaurant. In some embodiments, the business rating system 130 may only find historical transactions that are within the same geographic region (e.g., same postal code and/or adjacent postal codes), as the payee for which it is determining the business rating score. Once the business rating system 130 has found the matching and non-matching transactions for the payee, it will generate a business rating score for the payee (step 730). The business rating score may be based on ratio of the number of historical transactions associated with the payee compared to number of historical transactions not associated with the payee. The business rating system 130 may also use other factors when determining the business rating score, such as geography, volume of data for the payee, volume of data for the payee's category, or other data.

In some embodiments, the business rating system 130 may solicit user feedback and incorporate the feedback into business rating scores, such as the business rating scores determined with the processes described in FIG. 6 and FIG. 7. While the business rating system 130 uses spending transaction data to rate businesses, it may also incorporate user feedback as an input when determining business rating scores. The user feedback may be gathered through the use of surveys or user interfaces made available through the website or client application of the business rating system 130.

Returning to FIG. 4, once the business rating system 130 determines the business rating score, it may generate a user interface containing an indication of the score (step 450). The user interface may, for example, include a number indicating the business rating score. For example, the business rating score may be on a scale of 0 to 100, and the user interface may display a number in between 0 and 100. The business rating score may also provide an indication of the quality of the payee without a quantitative indication. For example, the business rating score may be text such as “poor,” “fair,” “average,” “good,” and “excellent.” The user interface may also include a graphic indication of the business rating, such as a color or graph. The user interface me be generated to display within a web browser, or it may be generated to display within a client side application. The client side application may include a mobile application.

Other embodiments will be apparent to those skilled in the art from consideration of the specification and practice of the disclosed embodiments. It is intended that the specification and examples be considered as exemplary only, with a true scope and spirit of the disclosed embodiments being indicated by the following claims. Furthermore, although aspects of the disclosed embodiments are described as being associated with data stored in memory and other tangible computer-readable storage mediums, one skilled in the art will appreciate that these aspects can also be stored on and executed from many types of tangible computer-readable media, such as secondary storage devices, like hard disks, floppy disks, or CD-ROM, or other forms of RAM or ROM. Accordingly, the disclosed embodiments are not limited to the above described examples, but instead is defined by the appended claims in light of their full scope of equivalents.

What is claimed is:

1. A system for providing business ratings, comprising:
one or more memory devices storing software instructions; and
one or more processors configured to execute the software instructions to:
access spending transaction data, the spending transaction data comprising at least:
a unique payor identifier,
a payee description,
a payee category code, and
a postal code;
determine a payee identification for the spending transaction data by comparing the spending transaction data to a plurality of known payees having the same payee category code as the spending transaction data;
access one or more historical spending transactions matching the payee category code; and
generate a business rating score for a payee associated with the determined payee identification based on at least the determined one or more historical spending transactions.

2. The system of claim 1, wherein the one or more processors are further configured to execute the software instructions to determine the payee identification by filtering the spending transaction data by the payee category code and the postal code.

3. The system of claim 1, wherein the one or more processors are further configured to execute the software instructions to determine the business rating score by a least:
determining payor historical transactions from the one or more historical transactions based at least in part on the unique payor identification;
determining payor historical transactions associated with the payee;
determining payor historical transactions not associated with the payee; and
comparing the payor historical transactions associated with the payee to the transactions not associated with the payee.

4. The system of claim 1, wherein the one or more processors are further configured to execute the software instructions to determine the business rating score by a least:
determining one or more historical transactions associated with the payee,
determining one or more historical transactions matching the payee category code not associated with the payee; and
comparing the one or more historical transactions associated with the payee to the one or more historical transactions not associated with the payee.

5. The system of claim 1, wherein the one or more processors are further configured to generate a user interface containing a representation of the business rating score.

6. The system of claim 1, wherein the one or more processors are further configured to generate the business rating score based at least in part on user survey data.

7. The system of claim 1, wherein the unique payor identifier is anonymous.

8. A computer-implemented method for determining a business rating, the method comprising:
accessing, by one or more processors, spending transaction data, the spending transaction data comprising:
a unique payor identifier,
a payee description,
a payee category code, and
a postal code;
determining, by the one or more processors, a payee identification for the spending transaction data by comparing the spending transaction data to a plurality of known payees having the same payee category code as the spending transaction data;
accessing, by the one or more processors, one or more historical spending transactions matching the payee category code; and
generating, by the one or more processors, a business rating score for a payee associated with the determined payee identification, the business rating score being based at least in part on the determined one or more historical spending transactions.

9. The method of claim 8 wherein the payee identification is determined by filtering the spending transaction data by the payee category code and the postal code.

10. The method of claim 8 wherein the business rating score is determined by at least:
determining payor historical transactions from the one or more historical transactions based at least in part on the unique payor identification;
determining payor historical transactions associated with the payee;
determining payor historical transactions not associated with the payee; and
comparing the payor historical transactions associated with the payee to the transactions not associated with the payee.

11. The method of claim 8 wherein the business rating score is determined by at least:
determining one or more historical transactions associated with the payee;
determining one or more historical transactions matching the payee category code not associated with the payee; and
comparing the one or more historical transactions associated with the payee to the one or more historical transactions not associated with the payee.

12. The method of claim 8 further comprising generating a user interface containing a representation of the business rating score.

13. The method of claim 8 wherein the business rating score is generated based at least in part on user survey data.

14. The method of claim 8 wherein the unique payor identifier is anonymous.

15. A non-transitory computer readable medium storing instructions that, when executed by one or more processors, causes the one or more processors to perform operations comprising:
accessing spending transaction data, the spending transaction data comprising:
a unique payor identifier,
a payee description,
a payee category code, and
a postal code;
determining a payee identification for the spending transaction data by comparing the spending transaction data to a plurality of known payees having the same payee category code as the spending transaction data;
accessing one or more historical spending transactions matching the payee category code; and
generating a business rating score for a payee associated with the determined payee identification, the business rating score being based at least in part on the determined one or more historical spending transactions.

16. The non-transitory computer readable medium of claim 15, wherein the payee identification is determined by filtering the spending transaction data by the payee category code and the postal code.

17. The non-transitory computer readable medium of claim 15, wherein the instructions further cause the one or more processors to perform operations comprising:
determining payor historical transactions from the one or more historical transactions based at least in part on the unique payor identification;
determining payor historical transactions associated with the payee;
determining payor historical transactions not associated with the payee; and
comparing the payor historical transactions associated with the payee to the transactions not associated with the payee.

18. The non-transitory computer readable medium of claim 15, wherein the instructions further cause the one or more processors to perform operations comprising:
determining one or more historical transactions associated with the payee;
determining one or more historical transactions matching the payee category code not associated with the payee; and
comparing the one or more historical transactions associated with the payee to the one or more historical transactions not associated with the payee.

19. The non-transitory computer readable medium of claim 15, wherein the instructions further cause the one or more processors to perform operations comprising generating a user interface containing a representation of the business rating score.

20. The non-transitory computer readable medium of claim 15, wherein the business rating score is generated based at least in part on user survey data.
